(19) United States
(12) Patent Application Publication
(10) Pub. No.: US 2026/0184130 A1
(43) Pub. Date: Jul. 2, 2026

(54) PROGRESSIVE-DISPLACEMENT NITROGEN SHOCK ABSORBER AND OPERATING METHOD THEREOF

(71) Applicant: JIANGSU KOMAN SAITE SHOCK ABSORBER CO., LTD, Nantong, Jiangsu (CN)

(72) Inventors: Taiyun Jiang, Nantong, Jiangsu (CN); Hailang Yu, Nantong, Jiangsu (CN); Jiaxin Qian, Nantong, Jiangsu (CN)

(21) Appl. No.: 18/847,593

(22) PCT Filed: Jun. 24, 2024
(86) PCT No.: PCT/CN2024/100854

§ 371 Date: Sep. 16, 2024

(30) Foreign Application Priority Data
Aug. 23, 2023 (CN) 202311069991.4

(51) Int. Cl. B60G 17/052; B60G 17/04

(52) U.S. Cl. CPC B60G 17/0523; B60G 17/0408; B60G 2202/415; B60G 2202/416

(57) ABSTRACT

A progressive-displacement nitrogen shock absorber and an operating method thereof are provided, including a conjoined seat, a compression regulating valve system, a nitrogen cylinder assembly, an inner cylinder, an outer cylinder, a piston valve system, a seal assembly and a piston rod. The inner cylinder is arranged inside the outer cylinder, and an annular cavity is formed between the inner cylinder and the outer cylinder. At least upper and lower groups of through holes are formed in an inner wall of the inner cylinder, and the inner cylinder is communicated with the annular cavity through the through holes. An oil path is formed among the nitrogen cylinder assembly, the compression regulating valve system and the inner cylinder. The piston valve system is arranged on the piston rod. The inner cylinder is divided into a restoration side and a compression side by the piston valve system.

### CROSS-REFERENCE TO RELATED APPLICATION

This application is a national stage application of International Patent Application No. PCT/CN 2024/100854, filed Jun. 24, 2024, which claims priority of the Chinese Patent Application No. 202311069991.4, filed with the China National Intellectual Property Administration on Aug. 23, 2023, and entitled “PROGRESSIVE-DISPLACEMENT NITROGEN SHOCK ABSORBER AND OPERATING METHOD THEREOF”, both of which are incorporated by references in their entities.

### TECHNICAL FIELD

The present disclosure relates to the technical field of shock absorbers, in particular to a progressive-displacement nitrogen shock absorber and an operating method thereof.

### BACKGROUND

The structure of the existing nitrogen shock absorber relates to a relation curve of force to speed, and there is no other variable and parameter involved. If the adjustment style of the nitrogen shock absorber tends to off-road, the driving comfort on paved roads or conventional off-road roads will be sacrificed generally. If the adjustment style of the nitrogen shock absorber tends to comfort, the vehicle support under off-road conditions will be not enough. Therefore, the comfort and off-road performance of vehicles often cannot be simultaneously taken into account.

### SUMMARY

Aiming at the defects and disadvantages in the prior art, an objective of the present disclosure is to provide a progressive-displacement nitrogen shock absorber and an operating method thereof.

In order to realize the above-mentioned objective, the technical solutions provided by the present disclosure are as follows. A progressive-displacement nitrogen shock absorber mainly includes a conjoined seat, a compression regulating valve system, a nitrogen cylinder assembly, an inner cylinder, an outer cylinder, a piston valve system, a seal assembly and a piston rod. The inner cylinder is arranged inside the outer cylinder, and an annular cavity is formed between the inner cylinder and the outer cylinder. An inner wall of the inner cylinder is provided with at least upper and lower groups of through holes are formed in an inner wall of the inner cylinder, and the inner cylinder is communicated with the annular cavity through the through holes. Sizes and quantities of the through holes are determined according to parameters of different vehicles. An oil path is formed among the nitrogen cylinder assembly, the compression regulating valve system and the inner cylinder. The piston rod is located inside the inner cylinder, and the piston valve system is arranged on the piston rod. The inner cylinder is divided into a restoration side and a compression side by the piston valve system. The seal assembly is located at an opening of the inner cylinder and limits the piston valve system.

Further, the nitrogen cylinder assembly includes a nitrogen cylinder. A floating piston is arranged inside the nitrogen cylinder. An air nozzle cover is arranged on a top of the nitrogen cylinder. An oil hole is formed in a bottom of the nitrogen cylinder to be communicated with the compression regulating valve system.

Further, the piston valve system includes a piston, a piston valve hole is formed in an interior of the piston, and valve slices are arranged on an upper and lower sides of the piston valve hole.

Further, each group of the through holes is arranged in an annular array.

An method of operating the progressive-displacement nitrogen shock absorber includes the following steps:
step 1, when the shock absorber is compressed from an initial state, a part of oil on a compression side passes through a piston valve hole of a piston valve system into the restoration side, a part of oil passes through through holes in an inner wall of an inner cylinder to enter into an annular cavity between the inner cylinder and an outer cylinder and then enters into the restoration side from the through holes in an other side of the inner wall of the inner cylinder, the oil is capable of entering into a nitrogen cylinder from the inner cylinder, and nitrogen is compressed by a floating piston to generate gas reaction force; and for the through holes in the inner wall of the inner cylinder that are different in size, quantity and position, different differential pressures are generated, and thus different damping forces are generated; in this case, the damping forces are relatively small to ensure driving comfort;
step 2, when a compression stroke exceeds the through hole in the inner wall of the inner cylinder, the differential pressure is mainly generated by the piston valve system, and large damping force is able to be generated to meet a support, jumping and other off-road working conditions of vehicles; and
step 3, when the shock absorber is recovered from the initial state, a part of oil is capable of flowing back to the inner cylinder from the nitrogen cylinder under an action of nitrogen reaction force, a part of oil passes through the piston valve hole of the piston valve system from the restoration side to enter into the compression side, a part of oil passes through the through holes in the inner wall of the inner cylinder to enter into the annular cavity between the inner cylinder and the outer cylinder and then enter into the compression side from the through holes in the other side of the inner wall of the inner cylinder; the through holes in the inner wall of the inner cylinder are different in size, quantity and position, thus different differential pressures are generated, and then different damping forces are generated; in this case, the damping forces are relatively small to ensure the comfort; when the restored stroke exceeds the through holes in the inner wall of the inner cylinder, the differential pressure is mainly generated by the piston valve system, and large damping forces are able to be generated to meet a stretching, buffer and other off-road working conditions of vehicles after jumping.

Further, the piston valve system is displaced between the through holes in an upper and lower sides of the inner cylinder; in the compression state, a part of oil enters into the nitrogen cylinder from the compression side through the through holes; and in the restoration state, a part of oil enters into the compression side from the nitrogen cylinder through the through holes, and a part of oil is conveyed from the piston valve system.

After the above-mentioned structure is adopted, the present disclosure has the following beneficial effects.

The change of damping force can be realized through different sizes of the compression amount and the stretching amount of the shock absorber, and the comfort of the conventional road surface and the vehicle support under the off-road working condition are simultaneously satisfied, so that the driving feeling is further improved.

### BRIEF DESCRIPTION OF THE DRAWINGS

FIG. 1 is a structural schematic view of a progressive-displacement nitrogen shock absorber.

FIG. 2 is a schematic view of a piston valve system located between through holes on upper and lower sides when a progressive-displacement nitrogen shock absorber is compressed.

FIG. 3 is a schematic view when a progressive-displacement nitrogen shock absorber is compressed in place.

FIG. 4 is a schematic view of a piston valve system located between through holes on upper and lower sides when a progressive-displacement nitrogen shock absorber is recovered.

FIG. 5 is a schematic view when a progressive-displacement nitrogen shock absorber is recovered.

### REFERENCE SIGNS IN DRAWINGS

1, conjoined seat; 2, compression regulating valve system; 3, nitrogen cylinder assembly; 31, nitrogen cylinder; 32, floating piston; 33, air nozzle cover; 34, oil hole; 4, inner cylinder; 5, outer cylinder; 6, piston valve system; 61, piston; 62, piston valve hole; 63, valve slice; 7, seal assembly; 8, piston rod; 9, annular cavity; and 10, through hole.

### DETAILED DESCRIPTION OF THE EMBODIMENTS

The present disclosure is further described below in combination with the drawings.

In order to make the objectives, technical solutions and advantages of the present disclosure clearer, the present disclosure will be further described in detail below in combination with the drawings and embodiments. It should be understood that, the embodiments described herein are only intended to illustrate but not to limit the present disclosure.

### Embodiment I

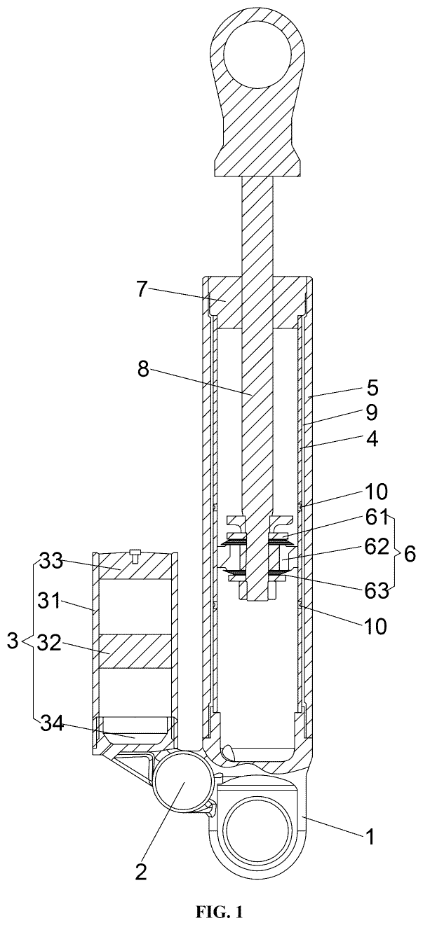

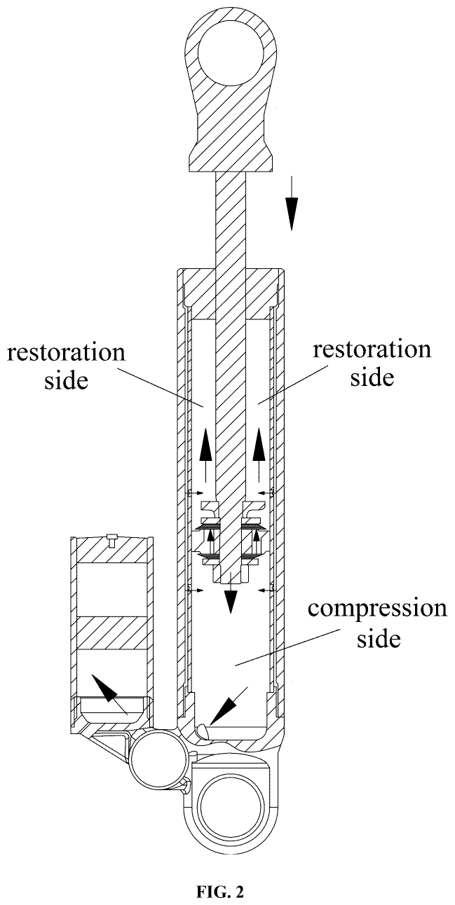

Referring to FIG. 1 to FIG. 5, a progressive-displacement nitrogen shock absorber mainly includes a conjoined seat 1, a compression regulating valve system 2, a nitrogen cylinder assembly 3, an inner cylinder 4, an outer cylinder 5, a piston valve system 6, a seal assembly 7 and a piston rod 8. The inner cylinder 4 is arranged inside the outer cylinder 5, and an annular cavity 9 is formed between the inner cylinder 4 and the outer cylinder 5. At least upper and lower groups of through holes 10 are formed in an inner wall of the inner cylinder 4, and the inner cylinder 4 is communicated with the annular cavity 9 through the through holes 10. The size and quantity of the through holes 10 are determined according to the parameters of different vehicles. An oil path is formed among the nitrogen cylinder assembly 3, the compression regulating valve system 2 and the inner cylinder 4. The piston rod 8 is located inside the inner cylinder 4, and the piston valve system 6 is arranged on the piston rod 8. The inner cylinder 4 is divided into a restoration side and a compression side (see FIG. 2 to FIG. 5) by the piston valve system 6. The seal assembly 7 is located at an opening of the inner cylinder and limits the piston valve system 6. Specifically, the upper and lower groups of through holes 10 are formed in the interior of the inner cylinder 4 of the shock absorber. According to different vehicle parameters, different sizes and quantities of through holes 10 are formed, thus ensuring not only comfort but also operation stability of vehicles under specific working conditions.

In the embodiment, the nitrogen cylinder assembly 3 includes a nitrogen cylinder 31, a floating piston 32 is arranged inside the nitrogen cylinder 31, an air nozzle cover 33 is arranged on the top of the nitrogen cylinder 31, and an oil hole 34 is formed in the bottom of the nitrogen cylinder to be communicated with the compression regulating valve system 2. The floating piston 32 moves up and down under the conditions of air pressure and hydraulic pressure to assist the shock absorber to realize the function of automatic adjustment.

In the embodiment, the piston valve system 6 includes a piston 61, a piston valve hole 62 is formed in the interior of the piston 61, and valve slices 63 are arranged on the upper and lower sides of the piston valve hole 62. The valve slice 63 is automatically opened and closed under the pressure of oil.

In the embodiment, each group of through holes 10 is arranged in an annular array.

### Embodiment II

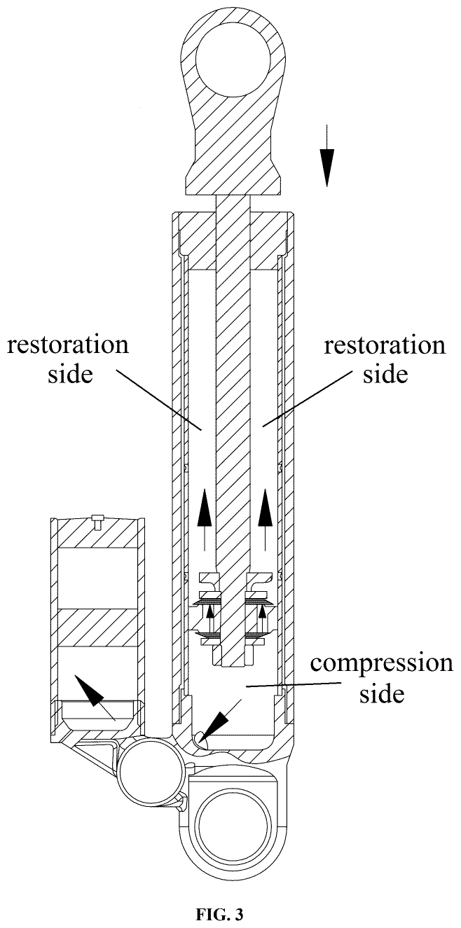

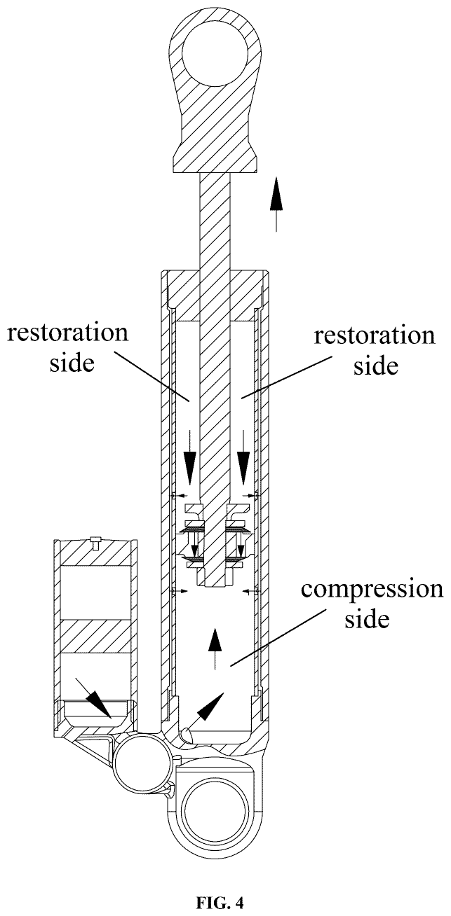

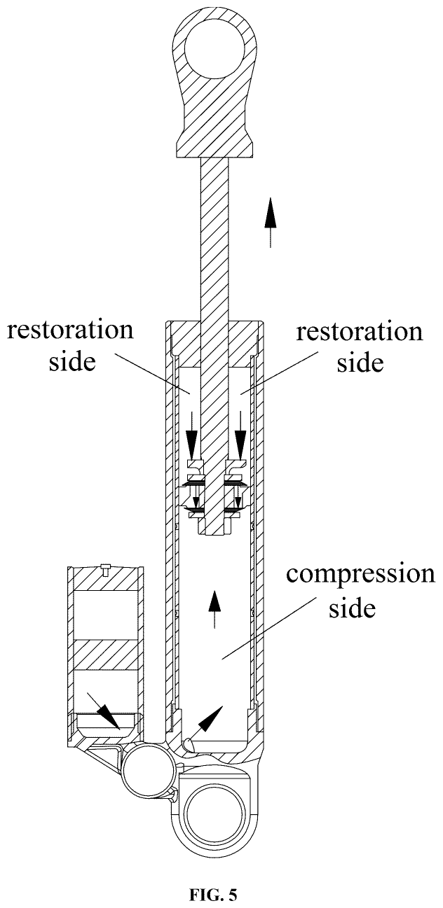

An method of operating the progressive-displacement nitrogen shock absorber includes the following steps:
step 1, when the shock absorber is compressed from the initial state, a part of oil on the compression side passes through the piston valve hole 62 of the piston valve system 6 into the restoration side, a part of oil passes through the through holes 10 in the inner wall of the inner cylinder 4 to enter into the annular cavity 9 between the inner cylinder 4 and the outer cylinder 5, and then enters into the restoration side from the through holes 10 in the other side of the inner wall of the inner cylinder 4, the oil (the volume of oil is equal to that of a part of the piston rod entering into an oil storage cylinder) can enter into the nitrogen cylinder 31 from the inner cylinder 4, and nitrogen is compressed by the floating piston 32 to generate gas reaction force (see FIG. 2); and for the through holes 10 in the inner wall of the inner cylinder 4 are different in size, quantity and position, thus different differential pressures are generated, and then different damping forces are generated; in this case, the damping forces are relatively small to ensure driving comfort;
step 2, when the compression stroke exceeds the through hole 10 (see FIG. 3) in the inner wall of the inner cylinder 4, the differential pressure is mainly generated by the piston valve system 6, and large damping force can be generated to meet the support, jumping and other off-road working conditions of vehicles; and
step 3, when the shock absorber is recovered from the initial state, a part of oil can flow back to the inner cylinder 4 from the nitrogen cylinder 31 under the action of nitrogen reaction force, a part of oil passes through the piston valve hole 62 of the piston valve system 6 from the restoration side to enter into the compression side, a part of oil passes through the through holes 10 in the inner wall of the inner cylinder 4 to enter into the annular cavity 9 between the inner cylinder 4 and the outer cylinder 5 and then enter into the compression side (see FIG. 4) from the through holes 10 in the other side of the inner wall of the inner cylinder 4; since the through holes 10 in the inner wall of the inner cylinder 4 are different in size, quantity and position, thus different differential pressures are generated, and then different damping forces are generated; in this case, the damping force are relatively small to ensure the comfort; when the restored stroke exceeds the through holes 10 in the inner wall of the inner cylinder 4, the differential pressure is mainly generated by the piston valve system 6, and large damping forces (see FIG. 5) can be generated to meet the stretching, buffer and other off-road working conditions of vehicles after jumping.

In the embodiment, the piston valve system 6 is displaced between the through holes 10 in the upper and lower sides of the inner cylinder 4; in the compression state, a part of oil enters into the nitrogen cylinder 31 from the compression side through the through holes 10; and in the restoration state, a part of oil enters into the compression side from the nitrogen cylinder 31 through the through holes 10, and a part of oil is conveyed from the piston valve system 6.

It should be noted that the above-mentioned embodiments are only used for illustrating but not restricting the technical solutions of the present disclosure. Other modifications or equivalent replacements of the technical solution of the present disclosure made by those skilled in the art should be fallen into the protection scope of claims of the present disclosure without departing from the scope and spirit of the technical solutions of the present disclosure.

What is claimed is:

1. A progressive-displacement nitrogen shock absorber, mainly comprising a conjoined seat, a compression regulating valve system, a nitrogen cylinder assembly, an inner cylinder, an outer cylinder, a piston valve system, a seal assembly and a piston rod,
wherein the inner cylinder is arranged inside the outer cylinder, and an annular cavity is formed between the inner cylinder and the outer cylinder; at least upper and lower groups of through holes are formed in an inner wall of the inner cylinder, and the inner cylinder is communicated with the annular cavity through the through holes; sizes and quantities of the through holes are determined according to parameters of different vehicles;
wherein an oil path is formed among the nitrogen cylinder assembly, the compression regulating valve system and the inner cylinder;
wherein the piston rod is located inside the inner cylinder, the piston valve system is arranged on the piston rod, and the inner cylinder is divided into a restoration side and a compression side by the piston valve system; and
wherein the seal assembly is located at an opening of the inner cylinder and limits the piston valve system.

2. The progressive-displacement nitrogen shock absorber according to claim 1, wherein the nitrogen cylinder assembly comprises a nitrogen cylinder, a floating piston is arranged inside the nitrogen cylinder, an air nozzle cover is arranged on a top of the nitrogen cylinder, and an oil hole is formed in a bottom of the nitrogen cylinder to be communicated with the compression regulating valve system.

3. The progressive-displacement nitrogen shock absorber according to claim 1, wherein the piston valve system comprises a piston, a piston valve hole is formed in an interior of the piston, and valve slices are arranged on an upper and lower sides of the piston valve hole.

4. The progressive-displacement nitrogen shock absorber according to claim 1, wherein each group of the through holes is arranged in an annular array.

5. A method of operating a progressive-displacement nitrogen shock absorber, comprising the following steps:
step 1, when the shock absorber is compressed from an initial state, a part of oil on a compression side passes through a piston valve hole of a piston valve system into a restoration side, a part of oil passes through through holes in an inner wall of an inner cylinder to enter into an annular cavity between the inner cylinder and an outer cylinder and then enters into the restoration side from the through holes in an other side of the inner wall of the inner cylinder, the oil is capable of entering into a nitrogen cylinder from the inner cylinder, and nitrogen is compressed by a floating piston to generate gas reaction force; and for the through holes in the inner wall of the inner cylinder that are different in size, quantity and position, different differential pressures are generated, and thus different damping forces are generated; in this case, the damping forces are relatively small to ensure comfort;
step 2, when a compression stroke exceeds the through holes in the inner wall of the inner cylinder, the differential pressure is mainly generated by the piston valve system, and large damping force is able to be generated to meet a support, jumping and other off-road working conditions of vehicles; and
step 3, when the shock absorber is recovered from the initial state, a part of oil is capable of flowing back to the inner cylinder from the nitrogen cylinder under an action of nitrogen reaction force, a part of oil passes through the piston valve hole of the piston valve system from the restoration side to enter into the compression side, a part of oil passes through the through holes in the inner wall of the inner cylinder to enter into the annular cavity between the inner cylinder and the outer cylinder and then enter into the compression side from the through holes in the other side of the inner wall of the inner cylinder; the through holes in the inner wall of the inner cylinder are different in size, quantity and position, thus different differential pressures are generated, and then different damping force are generated; in this case, the damping forces are relatively small to ensure the comfort; when the restored stroke exceeds the through holes in the inner wall of the inner cylinder, the differential pressure is mainly generated by the piston valve system, and large damping forces are able to be generated to meet a stretching, buffer and other off-road working conditions of vehicles after jumping.

6. The method of operating the progressive-displacement nitrogen shock absorber according to claim 5, wherein the piston valve system is displaced between the through holes in an upper and lower sides of the inner cylinder; in the compression state, a part of oil enters into the nitrogen cylinder from the compression side through the through holes; and in the restoration state, a part of oil enters into the compression side from the nitrogen cylinder through the through holes, and a part of oil is conveyed from the piston valve system.
